(19) United States
(12) Patent Application Publication
(10) Pub. No.: US 2023/0285225 A1
(43) Pub. Date: Sep. 14, 2023

(54) BURP BABY DEVICE

(71) Applicant: Miles Macy, Pacheco, CA (US)

(72) Inventor: Miles Macy, Pacheco, CA (US)

(21) Appl. No.: 17/689,571

(22) Filed: Mar. 8, 2022

(51) Int. Cl. A61H 23/00

(52) U.S. Cl. CPC A61H 23/006; A61H 23/004; A61H 2201/1623; A61H 2201/0134

(57) ABSTRACT

A method includes positioning a burping device at an initial position. The method also incudes identifying a padding area, and moving the padding area to a target area to provide continuous padding to a target area. The padding area is re-positioned in one or more intervals, wherein the padding area is set to a timer. The method also includes discontinuing the continuous padding to the target area.

### TECHNICAL FIELD

The present disclosure generally relates to a device to initiate a burp from an infant or baby.

### BACKGROUND

Inducing burping intervals of infants/babies can be challenging. Parents and baby-sitters will often want to induce burping intervals without causing undue harm to the back of infants.

Parents and baby-sitters also want to induce burping intervals in a time efficient manner. The parents and baby-sitters of the babies and infants do not want to take a long time having to pad the baby/infant in order to induce the burping interval(s).

As such, a need exists for an efficient system that can pad the back of the baby/infant in a pain-free way to where the baby/infant will not be adversely effected, and to where burping will be induced.

As padding the baby's back can be tedious and tiring, with parents and sitters not burping the baby long enough to help the babies to get rid of some of the air that babies tend to swallow during feeding.

Accordingly, there is a need be able to burp babies within zero to six months in a pain-free and efficient manner to induce single or multiple burping intervals. The babies need to be burped long enough to rid the air that they may swallow during feeding.

### SUMMARY

The following summary is provided to facilitate an understanding of some of the features of the disclosed embodiments and is not intended to be a full description. A full appreciation of the various aspects of the embodiments disclosed herein can be gained by taking the specification, claims, drawings, and abstract as a whole.

The aforementioned aspects and other objectives can now be achieved as described herein.

In an embodiment, a method includes positioning a burping device at a first position. The method also includes identifying a padding area located within the burping device. The padding area is moved to a target area to provide continuous area to the target area. The padding area is re-positioned in one or more intervals. The padding area is set to a timer. The continuous padding is discontinued to the target area.

The method also includes setting the timer to an interval of five minutes.

The continuous padding is discontinued when burping occurs from the target area.

The method also includes re-positioning the padding area during the continuous padding to the target area.

In an embodiment, a method includes configuring a burping apparatus at an initial position to provide burping to one or more target areas. The method also includes positioning at least one padding area within the burping apparatus onto at last one of the target areas. The padding area is set to one or more time intervals. Pressure is set for the padding areas, and a pace/rate of padding is set for the padding area. The method also includes an initiator that begins a continuous padding of the padding area on the at least one of the target areas.

The method also includes setting a pressure rate for the padding area to provide.

The one or more time intervals include time intervals of ten minutes and fifteen minutes.

The method also includes increasing the pace/rate of the padding on the at least one target area.

In an embodiment, a system includes a burping device configured at an initial position. The system also includes a padding area located within the burping device. The padding area is positioned to abut a target area to provide continuous padding to the target area. The padding area is re-positioned in one or more intervals. The padding area is set to a timer. A rotating mechanism discontinues the continuous padding to the target area.

The timer is re-set in response to a lack of burping intervals.

A pressure of the continuous padding is increased.

A pressure of the continuous padding is decreased in response to the one or more burping intervals.

### BRIEF DESCRIPTION OF THE FIGURES

The accompanying figures, in which like reference numerals refer to identical or functionally similar elements throughout the separate views and which are incorporated and form a part of the specification, further illustrate the present invention and, together with the detailed description of the invention, serve to explain the principles of the present invention.

FIG. 1 illustrates a system diagram in accordance with an embodiment of the invention;

FIG. 2 illustrates schematic process in accordance with the invention;

FIG. 3 illustrates a diagram in accordance with the invention;

FIG. 4 illustrates a diagram in accordance with the invention;

FIG. 5 illustrates a diagram in accordance with an embodiment of the invention; and

FIG. 6 depicts a flow chart in accordance with an embodiment of the invention.

Unless otherwise indicated illustrations in the figures are not necessarily drawn to scale.

### DETAILED DESCRIPTION OF SOME EMBODIMENTS

### Background and Context

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different form and, therefore, covered or claimed subject matter is intended to be construed as not being limited to any example embodiments set forth herein, example embodiments are provided merely to be illustrative. Likewise, a reasonably broad scope for claimed or covered subject matter is intended. Among other issues, subject matter may be embodied as methods, devices, components, or systems. The followed detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein may not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Generally, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as a “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

One having ordinary skill in the relevant art will readily recognize the subject matter disclosed herein can be practiced without one or more of the specific details or with other methods. In other instances, well-known structures or operations are not shown in detail to avoid obscuring certain aspects. This disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Unless defined otherwise, all technical and scientific terms used herein have the same meanings as commonly understood by one of ordinary skill in the art to which the disclosed embodiments belong. Preferred methods, techniques, devices, and materials are described, although any methods, techniques, devices, or materials similar or equivalent to those described herein may be used in the practice or testing of the present invention.

Although claims have been included in this application to specific enumerated combinations of features, it should be understood the scope of the present disclosure also includes any novel feature or any novel combination of features disclosed herein.

References “an embodiment,” “example embodiment,” “various embodiments,” “some embodiments,” etc., may indicate that the embodiment(s) so described may include a particular feature, structure, or characteristic, but not every possible embodiment necessarily includes that particular feature, structure, or characteristic.

Headings provided are for convenience and are not to be taken as limiting the present disclosure in any way.

Each term utilized herein is to be given its broadest interpretation given the context in which that term is utilized.

### Terminology

The following paragraphs provide context for terms found in the present disclosure (including the claims):

The transitional term “comprising”, which is synonymous with “including,” “containing,” or “characterized by,” is inclusive or open-ended and does not exclude additional, unrecited elements or method steps. See, e.g., Mars Inc. v. H.J. Heinz Co., 377 F.3d 1369, 1376, 71 USPQ2d 1837, 1843 (Fed. Cir. 2004) (“[L]ike the term ‘comprising,’ the terms ‘containing’ and ‘mixture’ are open-ended.”). “Configured to” or “operable for” is used to connote structure by indicating that the mechanisms/units/components include structure that performs the task or tasks during operation. “Configured to” may include adapting a manufacturing process to fabricate components that are adapted to implement or perform one or more tasks.

“Based On.” As used herein, this term is used to describe factors that affect a determination without otherwise precluding other or additional factors that may affect that determination. More particularly, such a determination may be solely “based on” those factors or based, at least in part, on those factors.

All terms of example language (e.g., including, without limitation, “such as”, “like”, “for example”, “for instance”, “similar to”, etc.) are not exclusive of other examples and therefore mean “by way of example, and not limitation . . . ”.

A description of an embodiment having components in communication with each other does not infer that all enumerated components are needed.

A commercial implementation in accordance with the scope and spirit of the present disclosure may be configured according to the needs of the particular application, whereby any function of the teachings related to any described embodiment of the present invention may be suitably changed by those skilled in the art.

The flowchart and block diagrams in the figures illustrate the architecture, functionality, and operation of possible implementations of systems and methods according to various embodiments. Functions noted in the block may occur out of the order noted in the figures. For example, two blocks shown in succession may, in fact, be executed substantially concurrently, or the blocks may sometimes be executed in the reverse order, depending upon the functionality involved.

Further, any sequence of steps that may be described does not necessarily indicate a condition that the steps be performed in that order. Some steps may be performed simultaneously.

The functionality and/or the features of a particular component may be alternatively embodied by one or more other devices that are not explicitly described as having such functionality/features. Also, various embodiments of the present invention need not include a device itself.

More specifically, as will be appreciated by one skilled in the art, aspects of the present invention may be embodied as a system and/or method. Furthermore, aspects of the present invention may take the form of a plurality of systems to enable gas meter to perform self-checking to determine its overall functioning without requiring a meter operator.

### Introduction

Embodiments of the present invention include a baby-burping device that includes a padded portion that provides padding to one or more areas on the back of an infant. The padding on the back of the infant can produce single or multiple burping intervals of the infant

The baby-burping device will include internal components and mechanics that will enable users to set the pressure and rate of the padding portion on the infant. The internal mechanics will also enable the user to set the pressure, rate and time interval for the padding portion to pad the infant on the back to induce the one or more burping intervals.

If the user desires to induce a single burping interval, the pressure and rate can be set to a low or moderate level to induce the single burping interval. If the single burping interval is not induced, the user can increase to the pressure and rate of the padding portion to a higher level to induce the single burping interval. In addition, should the user desire to induce multiple burping intervals, the user can raise the pressure and rate of the padding portion to higher levels. The user is not confined to a certain level or range when setting the pressure and rate of the padding portion.

The user can also set the time interval as the user desires. For a single burping interval, the user can set a short time interval of one to two minutes in an embodiment. The user can increase the time interval if the single burping interval has not occurred. Moreover, the user can increase the time interval as he/she desires to induce multiple burping intervals. As with the pressure and rate, the user is not bound to a certain time interval or range to induce a single or multiple burping intervals. The user can set any time range or interval necessary or desired to induce burping intervals of the infant.

### System Structure

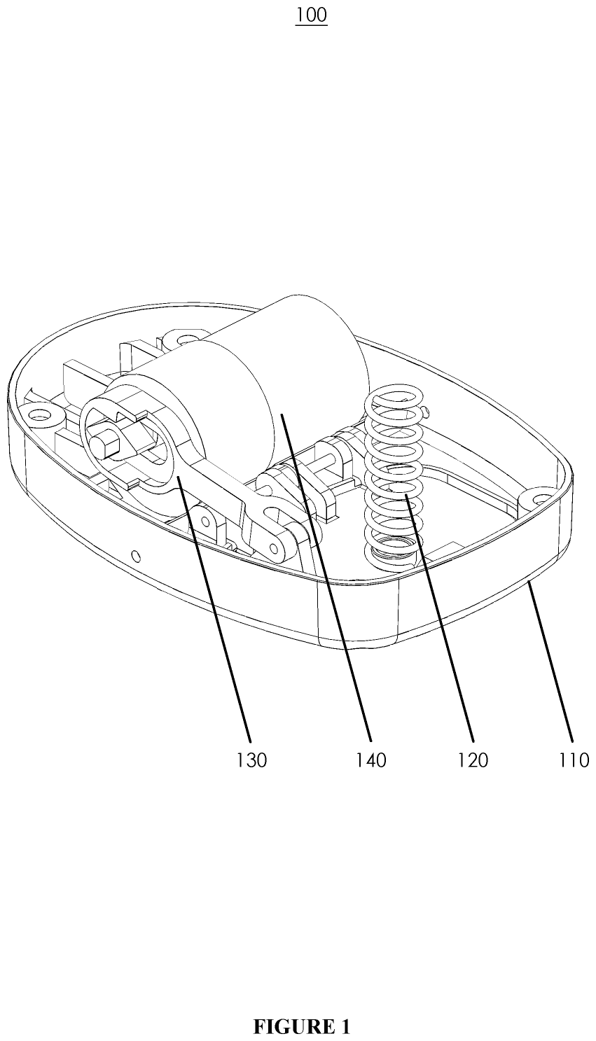

FIG. 1 illustrates a back end of a baby-burping device 100. The back end of the baby burping device 100 that is used to burp infants in one or more timing intervals. The back end of the baby-burping device 100 includes mechanics that enable the padding area of the baby-burping device 100 to continuously pad the baby's back in timing intervals.

Referring to FIG. 1, the base 110 is illustrated. On the top end of the base 110, the padding area (shown in later figures), will be used to pad the backs of infants. The coils 120 are shown. The coils 120 can be positioned directly in back of the padding area. The coils 120 will provide the up and down motion of the padding area. In other words, the coils 120 will enable to push the padding area up and down to enable the padding area to pad the infants. The mechanism 130 is also illustrated. The mechanism 130 includes a safety bolt and other safety mechanisms that hold the internal mechanism of the baby-burping device 100 in place. The mechanics 130 of the baby burping device 104) insure that the padding area is functioning properly has it holds the internal mechanics within the baby burping device 100 in place. A roller 140 is also in place. The roller 140 is also held in place by the mechanics 130, The roller 140 will also provide some friction for the cover that will be placed over the coils 120, and mechanics 130. As such, the roller 140 can provide any needed friction to hold the cover in place,

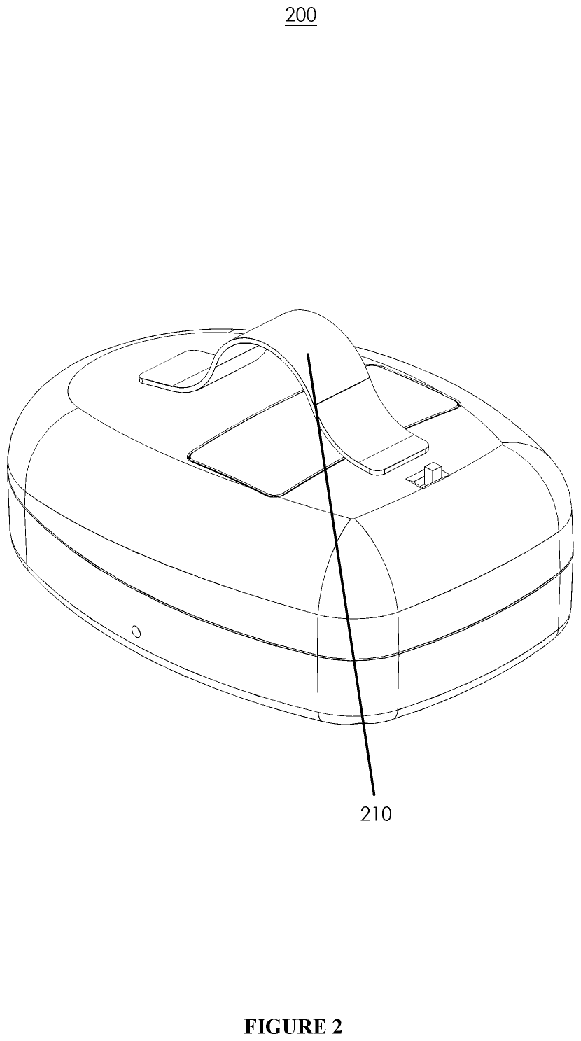

FIG. 2 illustrates the baby burping device 200 is shown at its top end. At the top end, a padding area 210 is shown. The padding area 210 is where the child/infant can be placed. The back of the infant can be placed in the padding area 210. The padding portion on top of the baby burping device 200 will then pad the back of the infant in a continuous motion.

Referring to FIG. 2, the pressure and intensity of the padding can be varied. The user can set and reset the pressure and intensity of the padding as needed, wherein the intensity and pressure can be increased and also decreased as needed. As such, when a burp is needed, the intensity and pressure of the padding can be increased. Further, the time interval can be adjusted as needed by the user. There is no required time interval. The user can set the time interval for a few minutes, or for an hour or so as examples. The timer is not set for a predetermined range. The mechanics mentioned in FIG. 1 will enable the user to set the time as needed.

In FIG. 2, when burping as occurred within the padding area 210, the pressure and intensity can be reduced. Alternatively, should additional burping be required, the user can increase the pressure, and intensity. Further, the user can also increase the time interval of the baby-burping device 200 to increase the possibility of additional burps. Overall, the user can set the parameters for the pressure, intensity, and time interval as needed to induce a single burp, or multiple burps of the infant within the padding area 210. The system 200 reduces the tedious need for the parents or baby-sitters to manual have to burp the baby. Further, the air that the baby swallows during feeding can leave the baby during the burping interval(s).

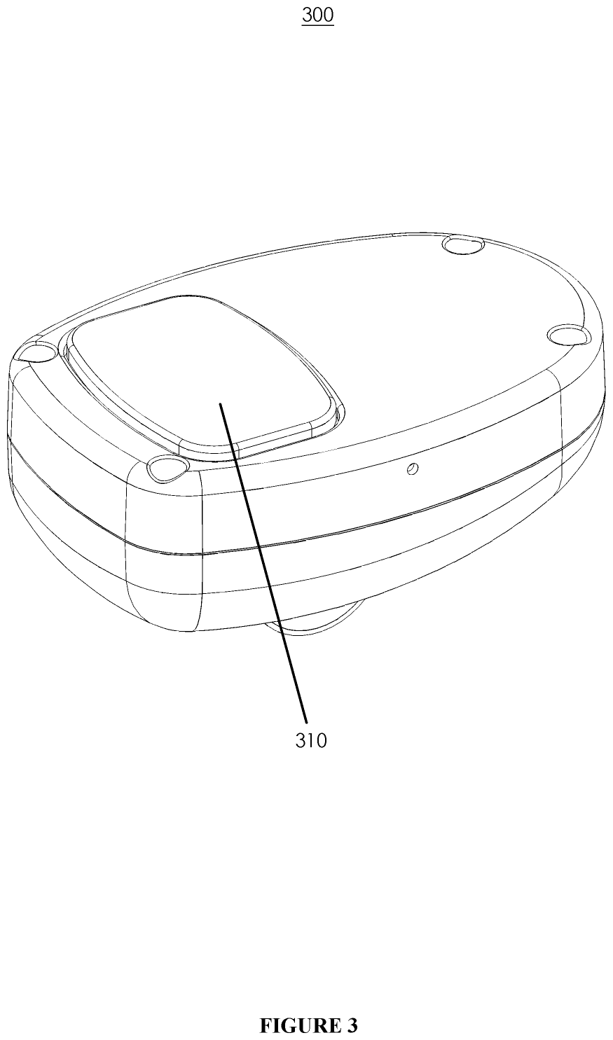

Referring to FIG. 3, the baby-burping device 300 is shown with the padding portion 310. The padding portion 310 will be conditioned to pad the baby/infant to induce one or more burping intervals. Underneath the padding portion 310, within the baby burping device 300, the mechanics of the baby burping device 300 will set the rate of the padding, intensity of the padding, time interval of the padding, and even the temperature where the padding occurs.

In FIG. 3, when the conditions of the padding such as the rate, intensity, duration, and temperature have been set by the mechanics, the padding of the infant can occur. The rate is not set to a specific speed. The rate can be set to a slow speed or a faster speed as needed. The user can set the rate to a slow speed to induce a single burp as an example. In contrast, the user can set the rate to a faster speed to induce a burping interval sooner, or to induce multiple burping intervals. With respect to intensity, the padding portion 310 is designed to provide a gentle padding onto the back of the infant. As such, the user can set a gentle intensity of the padding by the padding portion 310 to induce a single burp or multiple burps. If there is a situation in which a desired burping interval has not occurred, the user can increase the intensity of the padding to induce the one or more burping intervals.

Referring to FIG. 3, the duration or timing interval can be set to a short, intermediate, or long interval. The user can determine how many burping intervals would be required. According, should only a single burping episode be required, the user can set the duration to a short or intermediate time interval of zero to five minutes as an example. Different users can have different interpretations of short to intermediate intervals. Given these differences, the short to intermediate time interval can be two to ten minutes in other embodiments as well. As a result, when the burping interval has occurred, the infant can then be removed from the padding portion 310.

In FIG. 3, should the user desire multiple burping intervals, or should the infant not have a burping interval during the short and intermediate durations, the user can lengthen the duration to a longer time interval. There is not a set time range for the longer duration, and the user can determine the length for the longer interval. In some embodiments, the longer time interval can be 12-15 minutes. In other embodiments, the longer time interval can be greater than fifteen minutes. The user can use the longer time interval to induce the desired burping interval that did not occur previously during a shorter time interval. In addition, the user can use the longer time interval to induce multiple burping intervals for the infant as well.

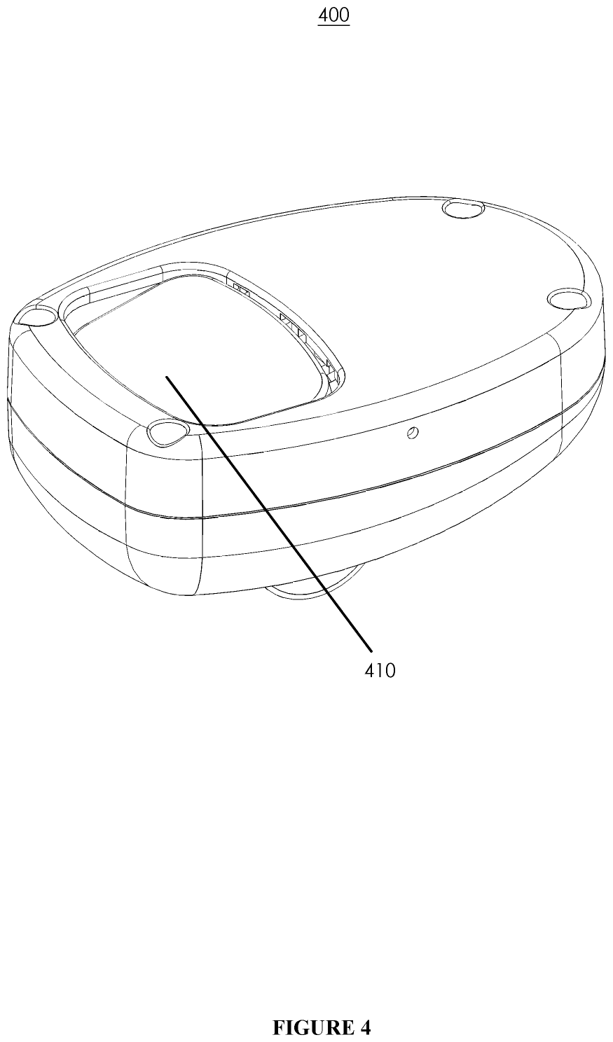

In FIG. 4, the baby-burping device 400 is issued with the padded portion 410 moving up and down in a padding motion. As in the figures described above, the pressure and rate of the padding portion 410 can vary. The rate and pressure can be slower and moderate to produce a single burping interval. The user can also increase the pressure and rate if a single burping interval has not been produces, or if the user wants to induce multiple burping intervals.

With respect to FIG. 4, the user can induce short, moderate, or long time intervals with respect to the padding portion 410 of the baby-burping device 400. To induce a single burping interval, with a high probability of occurrence, the user will likely set a short time interval from three to five minutes as an example. The interval can even be less than one minute if needed. If the user has been unsuccessful in obtaining the burping interval, or wants to induce multiple burping intervals, then the user can lengthen the interval for greater than five minutes. There is no limit as to the time in which the user can lengthen the time interval for the padding portion 410 to pad the infant.

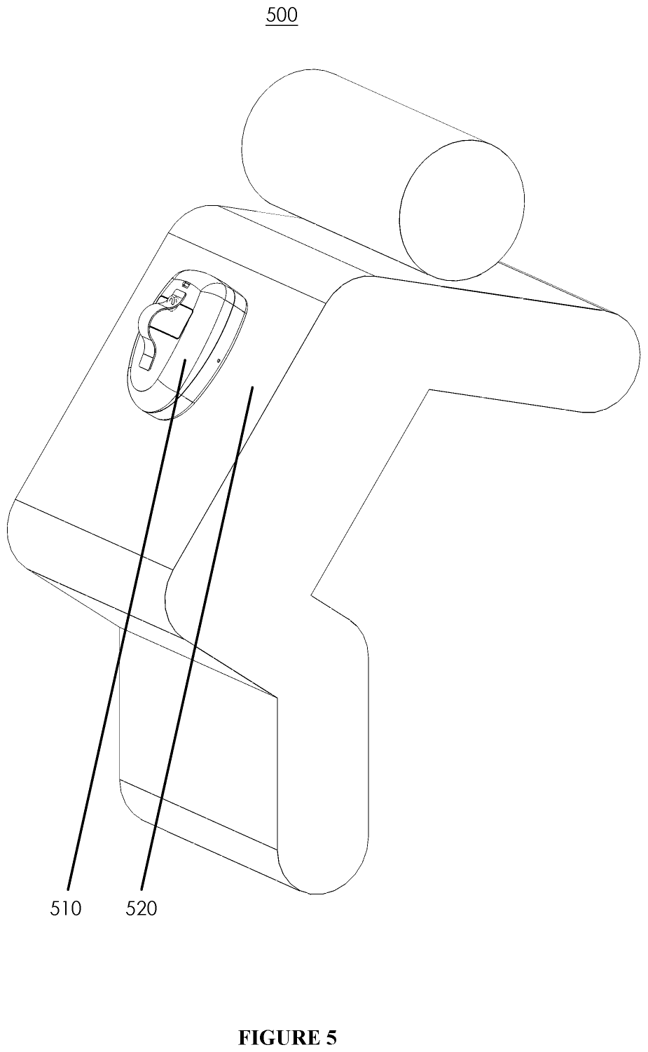

Referring to FIG. 5, a system 500 is illustrated with the baby-burping device 510 with the infant 520. The padding portion of the baby-burping device 510 will pad the infant 520 to induce one or more burping intervals. The user will set the pressure and rate as needed to induce one or more of the burping intervals. The user is not limited to a range with regard to the pressure or the rate of the padded portion that continuously pads the back of the infant 520 to induce the one or more burping intervals. The user can set the pressure and rate of the padding at any desired level. The user can lessen the pressure and rate to induce the single burping interval, or increase the pressure and rate to induce multiple burping intervals, or induce the single burping interval if a low or moderate pressure and rate are unable to induce the single burping interval.

In FIG. 5, the user can short a short, intermediate, or long-time interval as necessary to induce one or more burping intervals. The user is not limited to a time range with regard to the time interval. The user can determine that a short time interval of one minute suffices to induce a single burping interval. Further, the user can lengthen the time interval if the burping interval has not occurred. In addition, the user can lengthen the time interval of the padding session should multiple burping intervals be desired. As with the pressure and rate of the padding of the infant's back, the time interval is adjustable as desired by the user. The user will attempt to ensure that any air that the infant swallowed during feeding sessions can leave the infants during the one or more burping intervals.

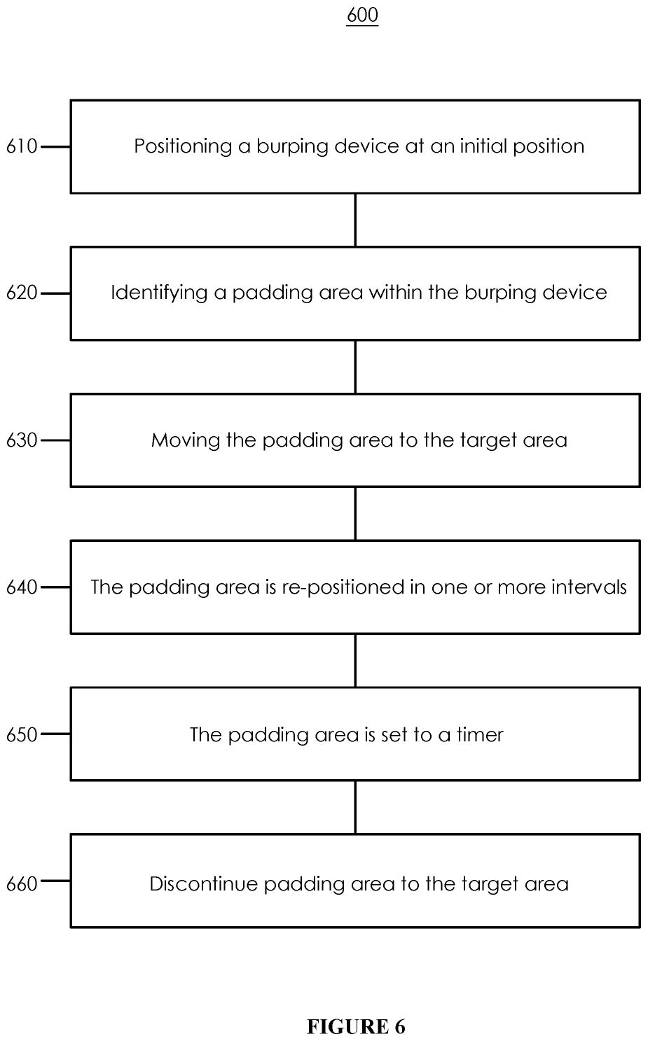

Referring to FIG. 6, the process 600 is illustrated for performing a burping sequence on an infant. The process 600 in which the infant is burped by the baby-burping device is described.

In FIG. 6, at step 610, the baby-burping device is positioned at an initial position. The initial position can be the back of the infant. At the back of the infant, the padded area of the baby-burping device can be positioned to pad the back of the baby to produce one or more burping intervals.

Referring to FIG. 6, at step 620, a padding area of the baby-burping device is identified. The padding area will be on the top portion of the baby-burping device. In addition, the padded area will be configured to move up and down to provide a padding effect to the back of the infant to induce one or more burping intervals of the infant.

In FIG. 6, at step 630, the padding area is moved to the target area of the infant. The position on the back of the infant is identified. As such, the padded area of the baby-burping device is then moved to that position of the back of the infant that was identified.

With respect to FIG. 6, at step 640, the padding area is re-positioned in one or more intervals. When the user determines that burping intervals have not been obtained, the user will re-positioned the padded area on a different portion of the infant to induce the burping intervals, whether it is a single burping interval, or multiple burping intervals. The user is not bound to the initial area on the infant to use the padded area of the baby-burping device. The user can move the padded area to different areas on the back of the infant to induce burping intervals.

In FIG. 6, at step 650, the padding area within the baby-burping device is set to pad the baby's back in relation to a timer set by the user. The user can determine the appropriate time. The time can be a short time interval, intermediate time interval, long time interval, or any time interval that the user determines is appropriate. The padding area will be configured to pad the back of the infant for the time interval set by the user.

Referring to FIGS. 6, at step 660, the padding on the infant is discontinued. The padding area of the baby-burping device is discontinued from padding the back of the infant. The user can discontinue the padding on the back of the infant after the user has determined that the one or more burping intervals have occurred.

Those skilled in the art will appreciate that the example embodiments are non-exhaustive and that embodiments other than that described here may be included without departing from the scope and spirit of the presently disclosed embodiments.

### Advantages/Summary

Overall, a user has a device that can produce multiple burping intervals for an infant. The user can locate the padding portion of the baby-burping device that will provide a padding motion on the back of the infant to induce the one or more burping intervals.

The user can determine the pressure and rate for the padding of the padding portion. The mechanics of the baby-burping device enable the user to adjust the pressure and rate of the padding portion. The user can set a low, moderate, or intense rate and pressure. The user can decide whether to induce a single burping interval, or multiple burping intervals. As such, to produce a single burping interval, the user can set the pressure and rate to moderate levels to induce the single burping interval. It the user is unable to obtain the single burping interval from the infant, or desires to induce multiple burping intervals, the user can increase the pressure and rate of the padding area to a higher level.

The user can also determine the time interval for the padding portion to pad the back of the infant. The user is not required to set a specific time interval for the padding on the back of the infant. The user can use a short, intermediate, long, or other time interval that the user determines is appropriate for the padding of the infant. The user can set a short or intermediate time interval to induce a single burping interval. In addition, the user can set a longer time interval if the single burping interval has not occurred, or if the user is attempting to induce multiple burping intervals on the infant.

In summary, the baby-burping device can induce single or multiple burping intervals using the padding portion of the baby-burping device. The user can use the mechanics of the baby-burping device to adjust the pressure, rate, and time interval for the padding portion as needed to induce the single or multiple burping intervals of the infant.

### CONCLUSION

All references, including granted patents and patent application publications, referred herein are incorporated herein by reference in their entirety.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Various aspects of the invention have been described above by way of illustration, and the specific embodiments disclosed are not intended to limit the invention to the particular forms disclosed. The particular implementation of the system provided thereof may vary depending upon the particular context or application. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

The corresponding structures, materials, acts, and equivalents of all means or step plus function elements in the claims below are intended to include any structure, material, or act for performing the function in combination with other claimed elements as specifically claimed.

What is claimed is:

1. A method comprising:
positioning a burping device at a first position;
identifying a padding area located within the burping device, moving the padding area to a target area to provide continuous padding to the target area, wherein the padding area is re-positioned in one or more intervals, and wherein the padding area is set to a timer; and
discontinuing the continuous padding to the target area.

2. The method of claim 1, further comprising:
setting the timer to an interval of five minutes.

3. The method of claim 1, wherein the continuous padding is discontinued when burping occurs from the target area.

4. The method of claim 1, further comprising:
re-positioning the padding area during the continuous padding to the target area.

5. The method of claim 1, further comprising:
adjusting a pressure of the continuous padding on the target area.

6. The method of claim 1, further comprising:
re-setting an additional time to the timer for the continuous padding.

7. The method of claim 1, further comprising:
adjusting a pace of the continuous padding.

8. A method comprising:
configuring a burping apparatus an initial position to provide burping to one or more target areas;
positioning at least one padding area within the burping apparatus onto at least one of the target areas, wherein the padding area is set to one or more time internals, wherein a pressure is set for the padding areas, and a pace/rate of padding is set for the padding area; and
an initiator that begins a continuous padding of the padding areas on the at least one of the target areas.

9. The method of claim 8, further comprising:
setting a pressure rate for the padding area to provide.

10. The method of claim 8, wherein the one or more time intervals includes time intervals of ten minutes and fifteen minutes.

11. The method of claim 8, further comprising:
increasing the pace/rate of padding on the at least one target area.

12. The method of claim 8, further comprising:
decreasing the pace/rate of the padding on the at least one target area.

13. The method of claim 12, wherein the pace/rate of the padding is decreased in response to one or more burping sounds from the at least one target area.

14. The method of claim 8, further comprising:
setting additional time intervals for the continuous padding to the at least one of the target areas.

15. A system comprising:
a burping device configured at an initial position;
a padding area located within the burping device, wherein the padding area is positioned to abut a target area to provide continuous padding to the target area, wherein the padding area is re-positioned in one or more intervals, and wherein the padding area is set to a timer; and
a rotating mechanism that discontinues the continuous padding to the target area.

16. The system of claim 15, wherein the timer is re-set in response to a lack of burping intervals.

17. The system of claim 15, wherein a pressure of the continuous padding is increased.

18. The system of claim 15, wherein a pressure of the continuous padding is decreased in response to one or more burping intervals.

19. The system of claim 15, wherein the timer is set for multiple burping intervals.

20. The system of claim 15, wherein a position of the padding area is adjusted with respect to the target area.
